(19) United States
(12) Patent Application Publication
(10) Pub. No.: US 2026/0280323 A1
(43) Pub. Date: Sep. 17, 2026

(54) ADAPTIVE BATTERY CHARGER

(71) Applicant: Bollinger Industries, Inc., Roanoke, TX (US)

(72) Inventors: Michael Silva, Hartford, CT (US); Fan Ding, Hartford, CT (US); Todd Marcucci, Mansfield, TX (US)

(73) Assignee: Bollinger Industries, Inc., Roanoke, TX (US)

(21) Appl. No.: 19/564,615

(22) Filed: Mar. 12, 2026

Related U.S. Application Data
(60) Provisional application No. 63/770,602, filed on Mar. 12, 2025.

(51) Int. Cl. H02J 7/70; H02J 7/44; H02J 7/60; H02J 7/82; H02J 7/90; H02J 7/94; H02J 7/96; H02J 7/00

(52) U.S. Cl. CPC H02J 7/751; H02J 7/44; H02J 7/60; H02J 7/82; H02J 7/933; H02J 7/94; H02J 7/96; H02J 7/875; H02J 2207/30; H02J 2207/40

(57) ABSTRACT

A universal adaptive battery charger is provided. The adaptive battery charger includes a USB power input, an adaptive output circuitry, preconfigured charging profiles, multi-chemistry support, and safety protections. The bi-directional power flow capability also facilitates use of the adaptive battery charger as a DC-to-DC charger for USB fast charging using normative or extended power voltage power delivery protocols.

### CROSS REFERENCE TO RELATED APPLICATIONS

This application claims the benefit of U.S. Provisional Application No. 63/770,602, filed on Mar. 12, 2025, which application is incorporated herein by reference in its entirety.

### TECHNICAL FIELD OF THE INVENTION

The present technology is generally related to a battery charger, and in particular, to an adaptive battery charger that uses Universal Serial Bus Type-C (USB-C) power delivery (PD) technology to charge batteries of various voltages and types.

### BACKGROUND OF THE INVENTION

Conventional existing battery chargers have many limitations. For example, conventional battery chargers have AC dependency and require access to an AC (mains) wall outlet. This limits portability and off-grid use. Conventional battery chargers also have a fixed output as most traditional chargers are set to fixed currents, requiring users to purchase multiple units. Some chargers may have a few current outputs in one charger, but they must be manually set or configured. Lastly, conventional battery chargers do not have solar integration as solar charging often requires additional controllers or adapters.

Thus, a need exists for a battery charger with adaptive input and dynamic output profiles for charging and/or maintaining batteries of various types and specifications using power sources not limited to wall outlets.

### SUMMARY

An adaptive battery charger is provided to address the gaps noted above. The adaptive battery charger can be connected to various power sources via USB-C connector with adaptive input and is capable of providing dynamic output profiles for charging and/or maintaining batteries of varying voltages and types. Additionally, the adaptive battery charger can also be used as a DC-to-DC charger when using the adaptive battery charger in a USB power mode.

Example aspects of the present disclosure include:

An adaptive battery charger according to at least one embodiment of the present disclose comprises a terminal connector configured to at least one of deliver an output power or to receive an input power; a USB connector configured to at least one of deliver the output power or to receive the input power; a power control circuit configured to (i) receive the input power, (ii) and negotiate power delivery between the terminal connector and the USB connector; a battery charging circuit configured to (i) receive the input power from the power control circuit and deliver the output power, and (ii) execute one or more safety check workflows prior to delivering the output power; a sensing circuit configured to (i) sense the input power via the power control circuit and one or more battery parameters via the battery charging circuit, and (ii) output sensor data corresponding to the input power and the one or more battery parameters; and a controller configured to (i) receive the sensor data, (ii) generate one or more commands based on the sensor data, and (iii) output the one or more commands to the power control circuit and the battery charging circuit to control delivery of the output power to charge an output device.

Any of the aspects herein, wherein the controller is configured to output user readable data, and wherein the adaptive battery charger further comprises: a display configured to (i) display the user readable data, and (ii) to receive user input.

Any of the aspects herein, wherein the user readable data comprises at least one of voltage, current, charge levels, or a selected mode.

Any of the aspects herein, wherein the controller is configured to receive the user input and to generate the one or more commands further based on the user input.

Any of the aspects herein, wherein the user input comprises the selected mode of a plurality of modes, and wherein each mode corresponds to a preset battery configuration.

Any of the aspects herein, wherein the input power is received at the USB connector, and the output power is delivered at the terminal connector.

Any of the aspects herein, wherein the terminal connector is connected to a battery and the USB connector connected to a power delivery source.

Any of the aspects herein, further comprising: a terminal connector circuit configured to receive input power at the terminal connector, and wherein the input power is received at the terminal connector, and the output power is delivered at the USB connector.

Any of the aspects herein, wherein the terminal connector is connected to a battery and the USB connector is connected to an output device receiving power from the adaptive battery charger.

Any of the aspects herein, wherein the terminal connector circuit is configured to connect to a battery to detect real-time battery conditions and to at least one of allow a charge or a discharge from the battery.

Any of the aspects herein, wherein the battery charging circuit includes a DC-to-DC circuit configured to receive DC input power and to deliver DC output power.

Any of the aspects herein, wherein the input power comprises an input voltage and an input current and the output power comprises an output voltage and an output current.

Any of the aspects herein, wherein the input voltage is different from the output voltage.

Any of the aspects herein, wherein the input current is different from the output current.

Any of the aspects herein, wherein the USB connector comprises USB-C.

Any of the aspects herein, further comprising: one or more output ports.

Any of the aspects herein, wherein the power control circuit negotiates power delivery between the terminal connector and the USB connector by executing a plurality of operations comprising the steps of: receiving, from the USB connector, information about an input power source; receiving, from the terminal connector, information about a requested power output; and approving the requested power output when the input power source is determined to be able to supply the requested power output.

An adaptive battery charger according to at least one embodiment of the present disclose comprises a terminal connector configured to at least one of deliver an output power or to receive an input power; a terminal connector circuit configured to receive the input power at the terminal connector; a USB connector configured to at least one of deliver the output power or to receive the input power; a power control circuit configured to (i) receive the input power, (ii) and negotiate power delivery between the terminal connector and the USB connector; a battery charging circuit configured to (i) receive the input power from the power control circuit and deliver the output power, and (ii) execute one or more safety check workflows prior to delivering the output power, wherein the battery charging circuit includes a DC-to-DC circuit configured to receive DC input power and to deliver DC output power; a sensing circuit configured to (i) sense the input power via the power control circuit and one or more battery parameters via the battery charging circuit, and (ii) output sensor data corresponding to the input power and the one or more battery parameters; and a controller configured to (i) receive the sensor data, (ii) generate one or more commands based on the sensor data, and (iii) output the one or more commands to the power control circuit and the battery charging circuit to control delivery of the output power to charge an output device.

An adaptive battery charger according to at least one embodiment of the present disclose comprises a terminal connector configured to at least one of deliver an output power or to receive an input power; a terminal connector circuit configured to receive the input power at the terminal connector; a USB connector configured to at least one of deliver the output power or to receive the input power; a power control circuit configured to (i) receive the input power, (ii) and negotiate power delivery between the terminal connector and the USB connector; a battery charging circuit configured to (i) receive the input power from the power control circuit and deliver the output power, and (ii) execute one or more safety check workflows prior to delivering the output power, wherein the battery charging circuit includes a DC-to-DC circuit configured to receive DC input power and to deliver DC output power; a sensing circuit configured to (i) sense the input power via the power control circuit and one or more battery parameters via the battery charging circuit, and (ii) output sensor data corresponding to the input power and the one or more battery parameters; and a controller configured to (i) receive the sensor data, (ii) generate one or more commands based on the sensor data, (iii) output the one or more commands to the power control circuit and the battery charging circuit to control delivery of the output power to charge an output device, and (iv) output one or more user-perceptible indicators correlating to one or more charging speed tiers based on the negotiated power delivery.

Any of the aspects herein, wherein the one or more charging speed indicators comprise at least three charging indicators comprising a first charging indicator corresponding to the negotiating power delivery being equal to or less than a first power threshold, a second charging indicator corresponding to the negotiating power delivery being equal to or less than a second power threshold, and a third charging indicator corresponding to the negotiating power delivery being equal to or less than a third power threshold, and wherein the third power threshold is greater than the second power threshold and the second power threshold is greater than the first power threshold.

Certain exemplary embodiments of the invention, as briefly described above, are illustrated by the following figures.

### BRIEF DESCRIPTION OF THE DRAWINGS

FIG. 1A shows an adaptive battery charger in accordance with embodiments of the present disclosure.

FIG. 1B shows another embodiment of an adaptive battery charger in accordance with embodiments of the present disclosure.

FIG. 1C shows an embodiment of a display of an adaptive battery charger in accordance with embodiments of the present disclosure.

FIG. 2 shows a block diagram of the adaptive battery charger in accordance with embodiments of the present disclosure.

FIG. 3 shows a dataflow in accordance with embodiments of the present disclosure.

FIG. 4A illustrates an example first charging profile in accordance with embodiments of the present disclosure.

FIG. 4B illustrates an example second charging profile in accordance with embodiments of the present disclosure.

FIG. 4C illustrates an example third charging profile in accordance with embodiments of the present disclosure.

FIG. 5 shows a dataflow in accordance with embodiments of the present disclosure;

FIG. 6 shows a flowchart in accordance with embodiments of the present disclosure.

### DETAILED DESCRIPTION OF PREFERRED EMBODIMENTS

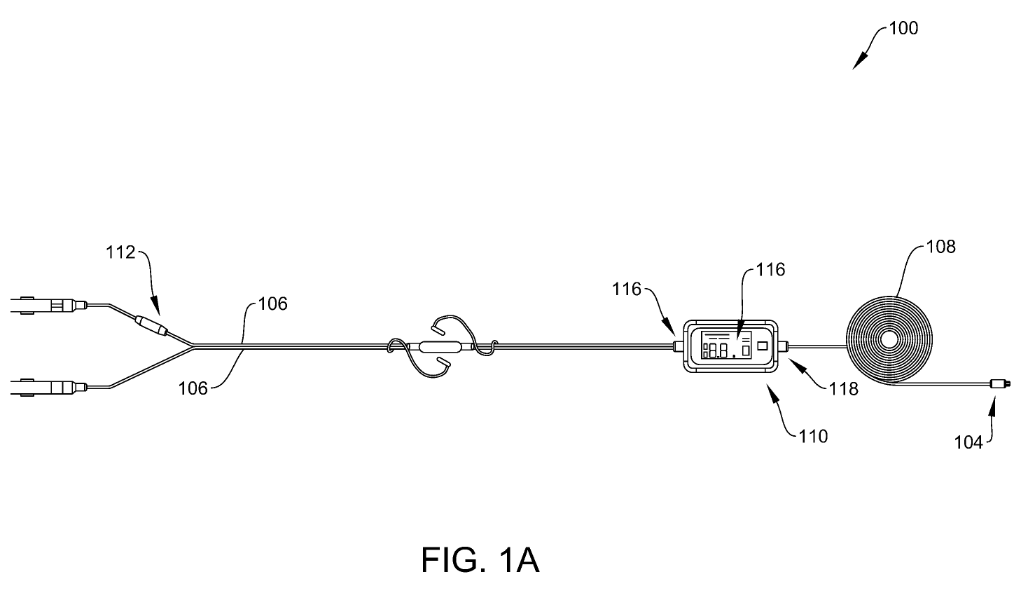

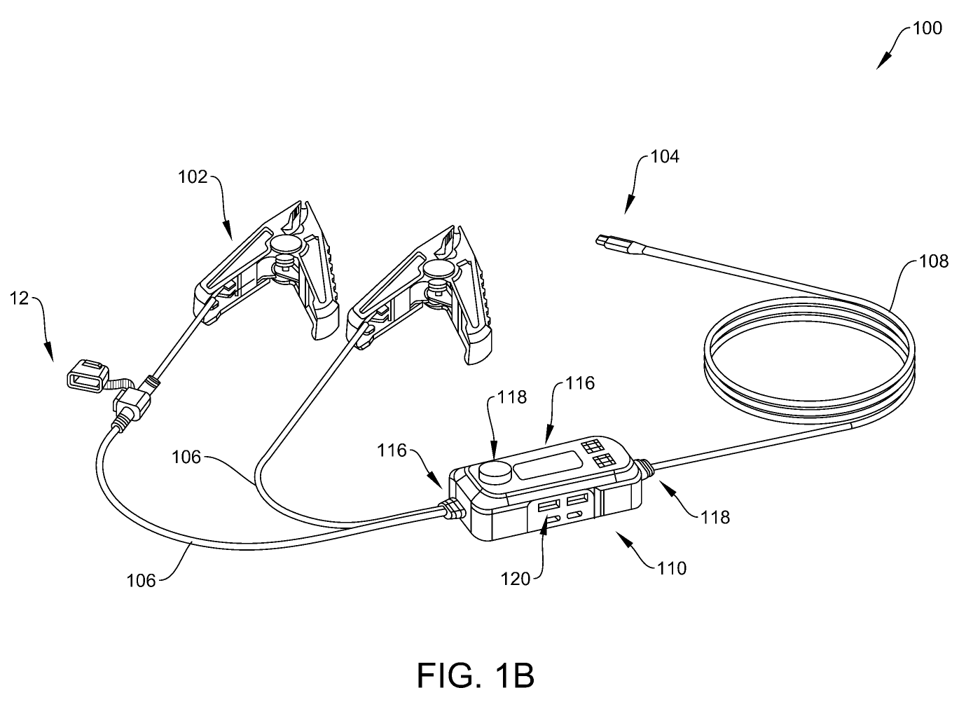

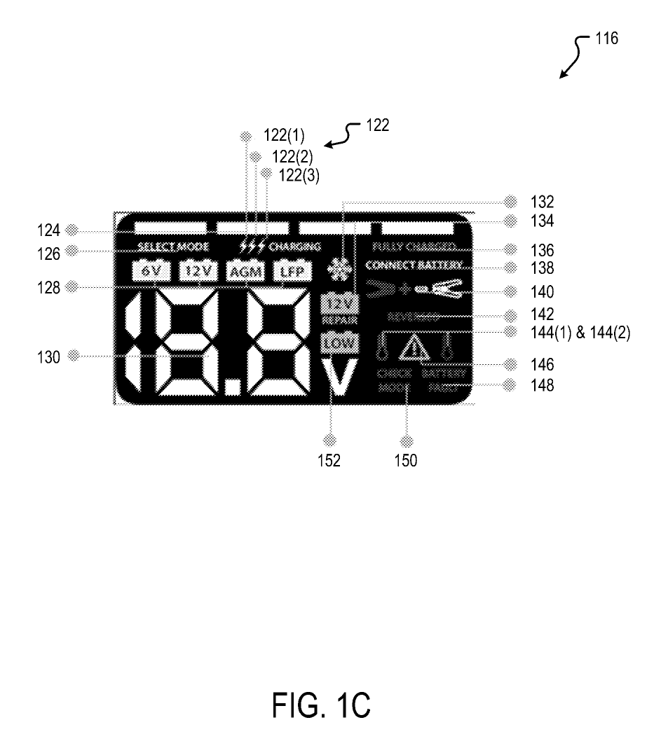

Turning to FIGS. 1A and 1B, an adaptive battery charger (also referred to as a “charger”) (100) is shown. The charger (100) beneficially enables charging or maintenance of batteries (whether external or internal, inside of, for example, a device) of varying voltages and currents and battery types via USB-C compatible power sources, also of varying voltages and currents, and multiple charging profiles stored in the charger (100). In some embodiments, the charger (100) can also beneficially enable DC-to-DC charging (in addition to AC-to-DC charging).

As shown, the charger (100) includes terminal connector(s) (102) and a USB connector (104). The terminal connectors (102) are configured to connect to a battery and deliver variable output power to charge the battery. For example, the variable output power can include 1-20A @ 12V/24V adjustable output with multiple application and/or device-type preset profiles (e.g., preset profiles for batteries used in scooters, motorcycles, ATVs, snowmobiles, lawn tractors, cars, SUVs, Trucks, RVs, etc.).

In some embodiments, the terminal connectors (102) are also configured to receive input power from the battery to, for example, charge a battery or an internal battery of a device via DC-to-DC charging. As shown, the terminal connectors (102) are a pair of alligator clamps or clips for connecting to terminals of a battery. In other embodiments, the terminal connectors (102) can be ring connectors, a 12V auxiliary port, or any other connection for connecting a battery to the charger (100). In still other embodiments, the terminal connectors (102) may be interchangeable such that different connectors can be changed and used as the terminal connectors (102). Further, the terminal connectors (102) can be connected to and disconnected from terminal connector cables (106) (or any other medium connecting the terminal connectors (102) to the housing (110)) using tool-less and/or quick connect couplings such as, for example, push fittings, snap fittings, threaded fittings, etc.

The USB connector (104) is configured to connect to a USB-compatible power source and to receive variable input power from the power source. The variable input power can be, for example, 5V to 20V normative voltage and 28V - 48V extended power voltage. The power source can be, for example, a wall outlet, solar panels, a power supply, a battery pack, portable power banks, portable power stations, portable solar generators, USB-compatible solar panels, and/or other USB-compatible devices.

In some embodiments, the USB connector (104) can also deliver output power to charge a USB-compatible device such as, for example, a phone, a laptop, etc. In some embodiments, the USB connector (104) is a USB-C connector, though in other embodiments, the USB connector (104) can be any USB connection.

The terminal connector (102) and the USB connector (104) are connected to a housing (110) via the terminal connector cables (106) and a USB cable (108), respectively. More specifically, the terminal connector cables (106) connect to the housing (110) at a terminal connector port (115) and the USB cable (108) connects to the housing (110) at a USB port (114). As shown, one of the terminal connector cables (106) includes a fuse (112) to protect circuits housed in the housing (110) from an overcurrent. Though not shown, the USB connector (104) may also include a fuse.

The housing (110) also includes a display (116) for displaying one or more user-readable data or outputs such as, for example, a voltage, a current, charge levels, or a selected mode. The display (116) can be an organic light-emitting diode (OLED) screen, a digital display, a liquid crystal display (LCD) screen, or the like.

The housing (110) also includes a user input device (118) (shown in FIG. 1B) to receive user input such as mode selection from multiple modes or preset profile selections. As shown, the user input device (118) is a rotary dial and buttons, though in other embodiments the user input device (118) can be any device to receive user input such as, for example, a touch screen, a switch, etc. The display (116) can also display selected modes and/or preset profiles.

As shown, the housing (110) also includes one or more output ports (120) (shown in FIG. 1B). In the illustrated embodiment, the output ports (120) are USB output ports, though the output ports (120) may be output port capable of receiving a corresponding connector. The output ports (120) can be used to charge additional devices and/or can be used to charge devices with different connections (e.g., USB-A, USB-B, etc.). The output ports (120) can be supplied power via a battery connected to the terminal connectors (102) and/or a power source connected to the USB connector (104).

The housing (110) can be any shape or size and can include more or less components. For example, the housing (110) may not include the one or more ports (120), or may include additional connectors, displays (116), or user input devices (118).

The charger (100) can include more or less components than illustrated and can include any combination of components. For example, the charger (100) shown in FIG. 1A may include the user input devices (118) and/or the output ports (120). In another example, the charger (100) shown in FIG. 1B may not include the output ports (120).

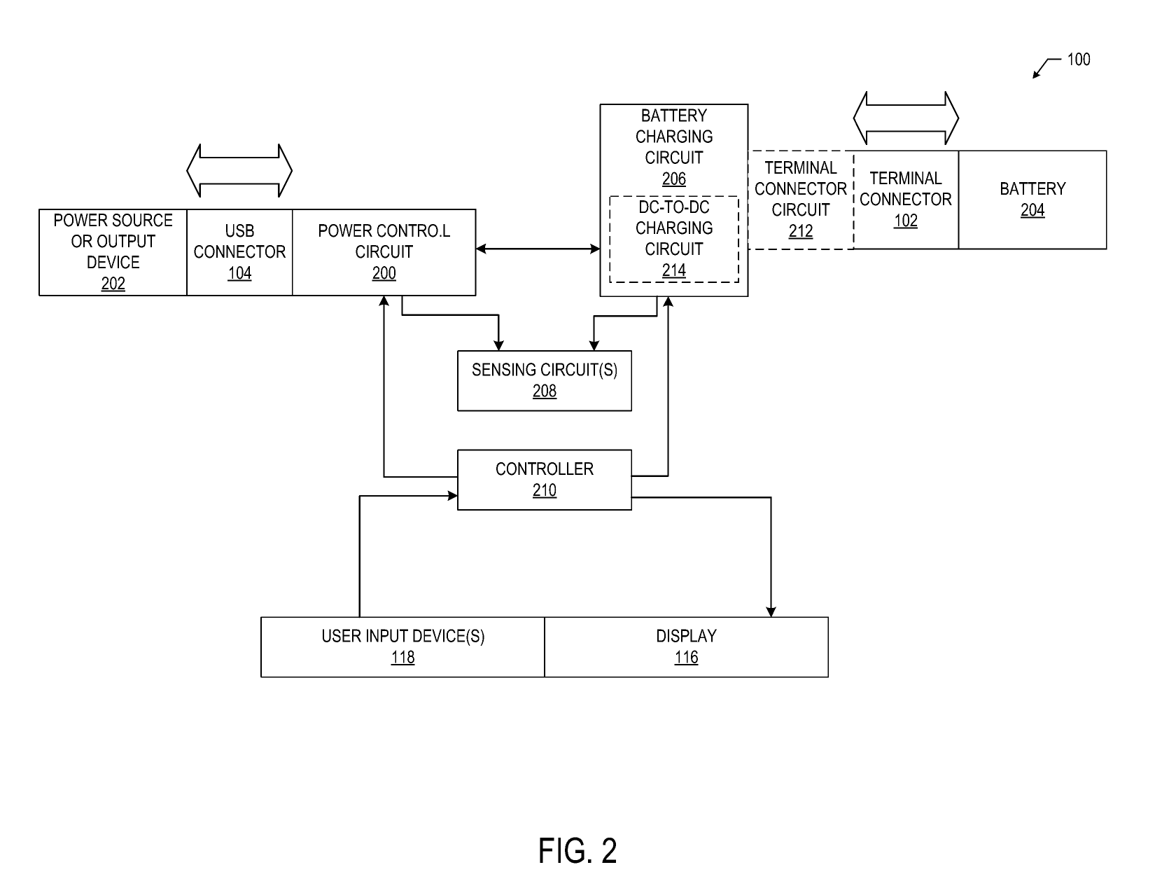

Turning to FIG. 2, a block diagram of the charger (100) is shown. The block diagram illustrates some components of the charger (100) as well as circuits that are internally housed in the housing (110). Generally, each circuit is configured to transfer power and/or execute or perform one or more tasks. Each circuit can include various electronic components such as, for example, resistors, transistors, diodes, or the like, as well as computational components such as processors, memory, etc. Some circuits may also include Gallium Nitride (GaM) technology for charging.

As shown, the charger (100) includes a power control circuit (200) configured to receive input power from a power source (202) or battery (204), or to deliver output power to the battery charging circuit (206). The power control (200) is also configured to negotiate power delivery between the terminal connector (102) and the USB connector (104). In some embodiments, negotiating the power delivery includes one or more steps, executed by the power control circuit (200), such as: receiving, from the USB connector (104), information about an input power source; receiving, from the terminal connectors (102), information about a requested power output; and approving the requested power output when the input power source is determined to be able to supply the requested power output. When the requested power output is approved, the charger (100) can begin delivering output power.

The power control circuit (200) can implement any protocol or standard for charging. For example, the power control circuit (200) can implement, power delivery (PD), bidirectional PD, quick charge (QC), programmable power supply (PPS), etc.

The charger (100) also includes a battery charging circuit (206). The battery charging circuit (206) is in communication with the power control circuit (200) to deliver power between the battery charging circuit (206) and the power control circuit (200). The battery charging circuit (206) is also configured to connect to the battery (204), receive the input power from the power control circuit (200) (at the negotiated voltage and current), and deliver the output power to the battery (204). The battery (204) can be any type of battery and of any voltage and/or current. For example, the battery (204) can be rated for 6V, 12V, or 24V and can be lead-acid, solid-state, absorbed glass mat (AGM), lithium ion phosphate (LFP), or any other battery type commonly used for automotive, marine, recreational, and/or lawn and garden applications.

The battery charging circuit (206) is also configured to execute one or more safety check workflows prior to delivering the output power. The safety check workflows can include, for example, detecting reverse polarity, checking for short circuit problems, detecting internal and external temperatures, protecting against over voltage, checking timing of charging.

In some embodiments, the battery charging circuit (206) can include a DC-to-DC charging circuit (214). In such embodiments, the DC-to-DC charging circuit (214) enables the charger (100) to use the battery (204) to charge an electronic device or a power station connected to the USB connector (104) or the output ports (120) using normative or extended power voltage power delivery protocols (i.e., fast charging a power station at 240W through a compatible power extended voltage port). In such embodiments, the device can also include a terminal connector circuit (212) to enable the terminal connector (102) to receive input power from the battery (204).

The charger (100) also includes a sensing circuit (208). The sensing circuit (208) is configured to sense the input power via the power control circuit (200) and one or more battery parameters via the battery charging circuit (206). The sensing circuit (208) is also configured to output sensor data corresponding to the input power, output power supplied for charging, and the one or more battery parameters. The sensor data can include, for example, an input voltage, an input current, an output voltage, an output current, an internal temperature of the housing (110), an external temperature of the housing (110), a battery condition, a lapsed time, etc.

The charger (100) also includes a controller (210). The controller (210) can be, for example, a microcontroller unit (MCU). The controller (210) is configured to receive the sensor data from the sensing circuit (208) and to generate one or more commands based on the sensor data. The controller (210) is also configured to output the one or more commands to the power control circuit (200) and the battery charging circuit (206) to control delivery of the output power to the battery (204) or an electronic device. For example, the controller (210) can dynamically fine tune and adjust the output current to the battery (204) based on real-time battery conditions and/or needs.

The charger (100) as shown can include more or less components. For example, in some embodiments, the charger (100) includes the DC-to-DC charging circuit (214). In other examples, the charger (100) may not include the DC-to-DC charging circuit (214).

Turning to FIG. 1C, an example display (116) is illustrated. The display (116) may include any number or combination of icons and/or indicators and may include icons and/or indicators that are not shown. The display (116) may also not include some icons and/or indicators that are illustrated.

As shown, the display (116) can include multiple charging speed indicators (122) that indicate a speed at which the charger (100) is charging the battery. The charging speed indicators (122) may correlate to different charging speed tiers based on a negotiated input power or power delivery. For example, when a first charging speed indicator (122)(1) is illuminated, the negotiated input power is less than or equal to a first input power (e.g., up to 9V); when a second charging speed indicator (122)(2) is illuminated, the negotiated input power is less than or equal to a second input power (e.g., up to 15V); and when a third charging speed indicator (122(3)) is illuminated, the negotiated input power is up to a third input power (e.g., 20V).

The display (116) also includes charging progress indicators (124) to display a charge progress, a select mode indicator (126) to display an indicator to a user to select a mode, mode indicators (128) indicating which mode is selected, a charging voltage display (130) displaying a voltage between battery terminals of a battery, a low battery indicator (152) indicating that the battery voltage is less than a low battery threshold (e.g., 6V, 12V, etc.), a check mode icon (150) indicating that the selected charging voltage mode selected does not match the voltage of the battery to be charged, a battery fault icon (148) indicating that a battery volage is out of the range for charging or an analysis stage that indicates there is a battery fault during charging, a caution icon (146) indicating a warning, a first temperature icon (144)(1) indicating that a temperature of the charger (100) meets or exceeds a first temperature threshold, a second temperature icon (144)(2) indicating that the temperature of the charger (100) is at or below a second temperature threshold, a reverse connection indicator (142) indicating that a reverse connection is detected, a pair of clamps (140) icons that is illuminated with the reverse connection indicator (142) or a connect battery indicator (138) is illuminated, the connect battery indicator (138) indicating to the user to connect the charger (100) to the battery, a fully charged indicator (136) indicating that the battery is fully charged, a repair mode icon (134) indicating that the repair mode is active, and/or a lower temperature indicator (132) indicating that charging the battery is at or below freezing temperatures.

It will be appreciated that any of the indicators and/or icons described above can be communicated to a user via the display (116) or other indicators such as, for example, an audible indicator, a tactile indicator, a visual indicator, or any combination thereof. The visual indicator can include, for example, text, images, light emitting diodes (LEDs), etc. In other words, the indicators and/or icons can be communicated to a user via any user-perceptible indicator.

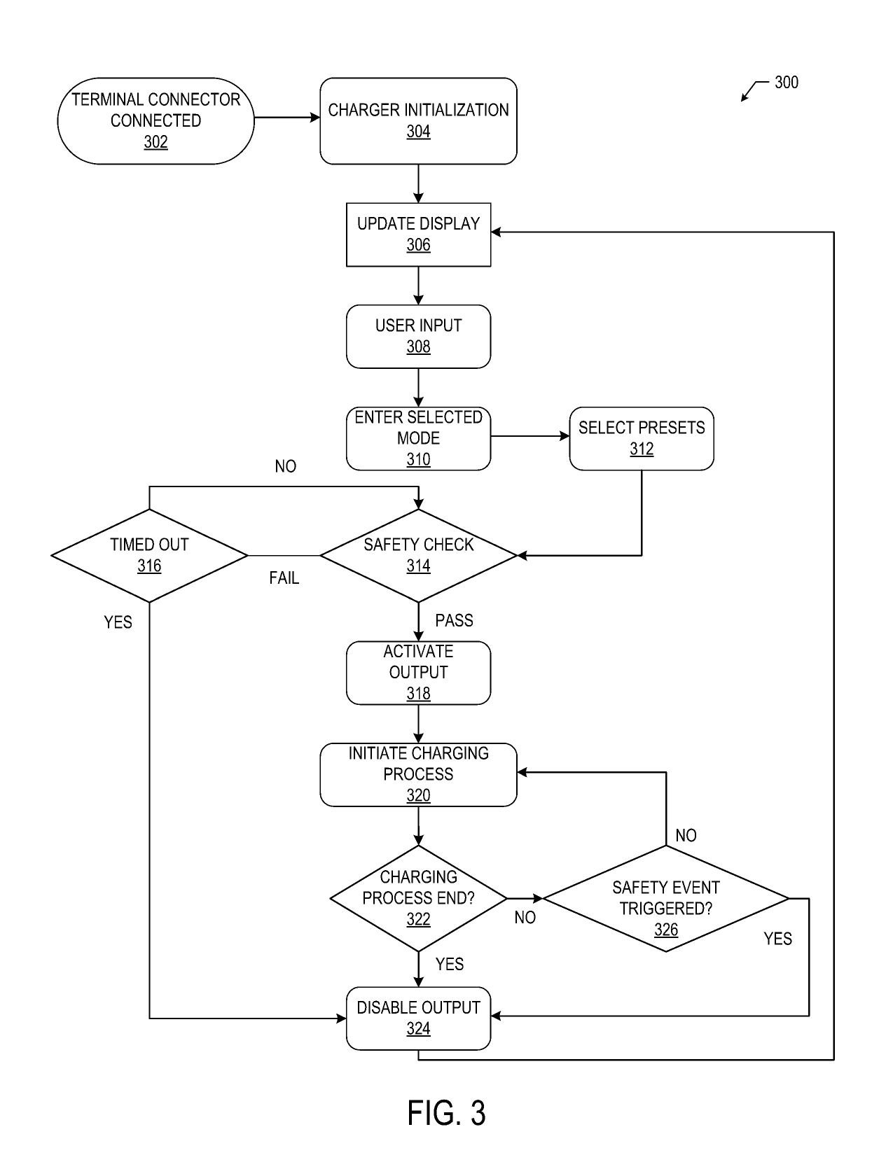

Turning to FIG. 3, a dataflow (300) illustrating a power flow from a USB connector such as the USB connector (104) to terminal connectors such as the terminal connectors (102) is shown. The dataflow (300) begins when the terminal connectors (102) are connected (302) to, for example, a battery such as the battery (204) and a device such as the device (100) is initialized (304).

The dataflow (300) then includes updating a display such as the display (116) and (306) to indicate that the device (100) is powered on. A user input (308) is then received via, for example, one or more user input devices such as the user input devices (118). As previously described, the user input can include a selection of a mode from multiple modes. The modes can include, for example, modes for various voltage ratings (of the battery (204)) and/or battery type, a USB charging mode (for charging power sources or electronic devices connected to the charger (100) via the USB connector (104) or the output ports (120), and/or a repair mode for repairing a lead-acid battery. For example, the modes can include a 12V mode, a 12V AGM mode, a 12V LFP mode, and a 6V mode.

The dataflow (300) includes entering the selected mode (310) and, in some modes, selecting a corresponding preset (312) of the selected mode (310). The preset (312) is the corresponding charging profile for the selected mode. For example, if the selected mode is the 12V mode, a charging profile for a 12V battery will be selected for charging the battery (204). The presets (312) can include charging profiles for, for example, charging in a 12V mode, a 12V absorbent glass mat (AGM) mode, a 12V lithium iron phosphate (LiFePO4) mode, and/or a 6V mode. It will be appreciated that the presets (312) include any number of presets (for any number of charging profiles).

Generally, the charging profile of a selected preset (312) for charging a battery includes a multi-stage control logic for effectively, and safely, charging the battery. The control logic can include, for example, a qualification stage, a soft start stage, a bulk stage, an absorption stage, a full stage, and/or a recharge stage. In some embodiments, the control logic can also include an analysis stage, a maintenance stage, and/or a recharging stage. More specifically, the qualification stage includes detecting a presence of an external battery with a battery voltage measurement and keeping the output off when the battery voltage measurement is below a predetermined qualification threshold.

The soft start stage includes providing a partial charge (e.g., a charge less than a full rated output) when the battery voltage measurement is between a range greater than the predetermined qualification threshold and less than a predetermined bulk threshold. The display (116) may display a charging voltage and a charging progress indicator. In some instances, if the soft stage exceeds a predetermined soft stage timer (e.g., 2 hours), then the output charge will be disabled and the display (116) will display the caution icon (146) with, for example, the battery fault icon (148) and/or the check mode icon (150).

The bulk stage includes providing a full charge (e.g., a charge at the full rated output) when the battery voltage measurement is between a range greater than the predetermined bulk threshold and less than a predetermined absorption threshold. The display (116) may continue to display the charging voltage (130) and the charging progress indicator(s) (124)

The absorption stage includes reducing a current of the charge when the battery voltage measurement is greater than the predetermined absorption threshold. The display (116) may continue to display the charging voltage (130) and the charging progress indicator(s) (124).

The full stage includes displaying the battery voltage (130), all charging progress indicators (124), and the full charged indicator (136), indicating that the battery is fully charged, when the battery voltage measurement meets a predetermined full threshold that is greater than the predetermined absorption threshold and when the charging current is less than a full current threshold.

The recharge stage includes returning to a normal charging mode to charge the battery when the battery voltage measurement is less than a recharge threshold that is less than the absorption threshold and/or the full threshold.

The analysis stage, which may be included in some charging profiles such as, for example, the 6V mode, the 12V mode, and the 12V AGM mode, includes stopping the charge and displaying the caution icon (146) and/or the battery fault icon (148) on the display (116) when the battery voltage measurement is below a predetermined fault threshold within a time threshold (e.g., one minute) after the battery is fully charged.

If the battery voltage measurement remains above the predetermined fault threshold for more than the time threshold after the battery is fully charged, then the maintenance stage may provide power to the battery to maintain the full charge.

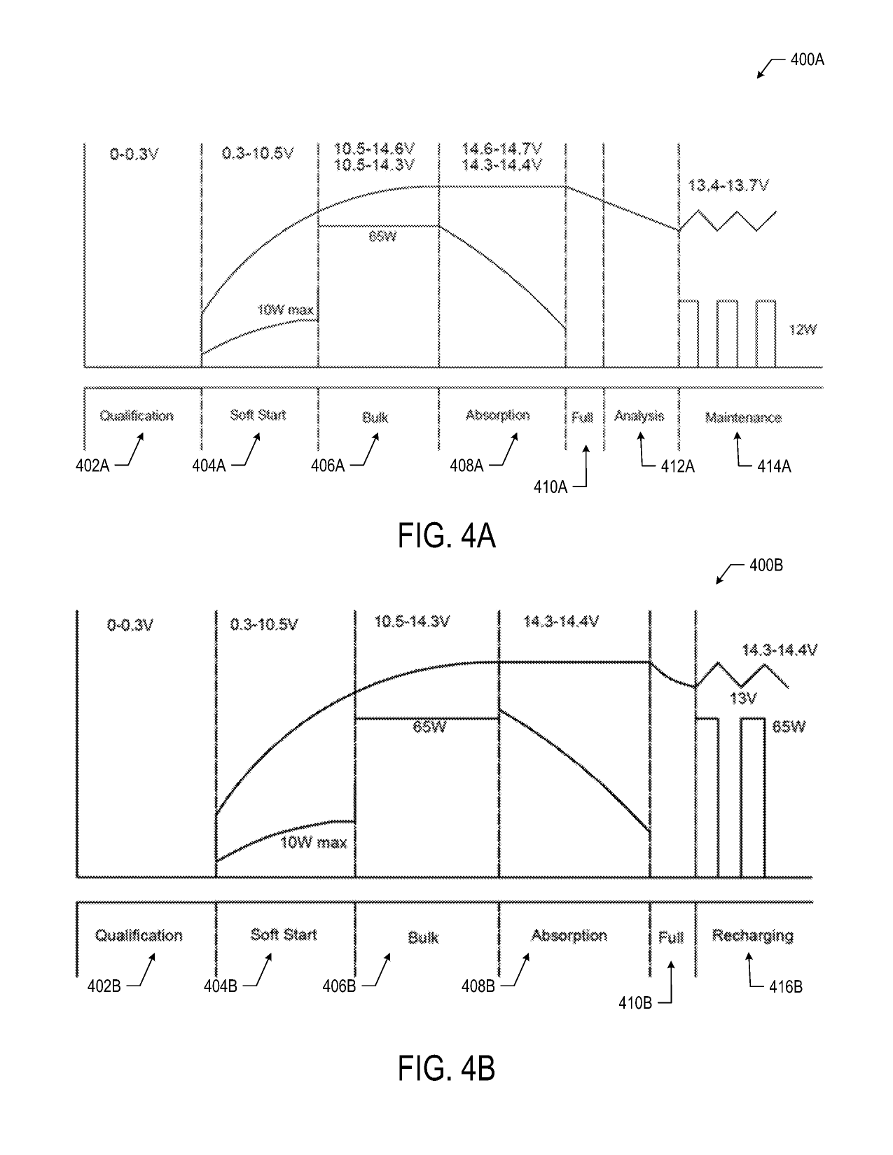

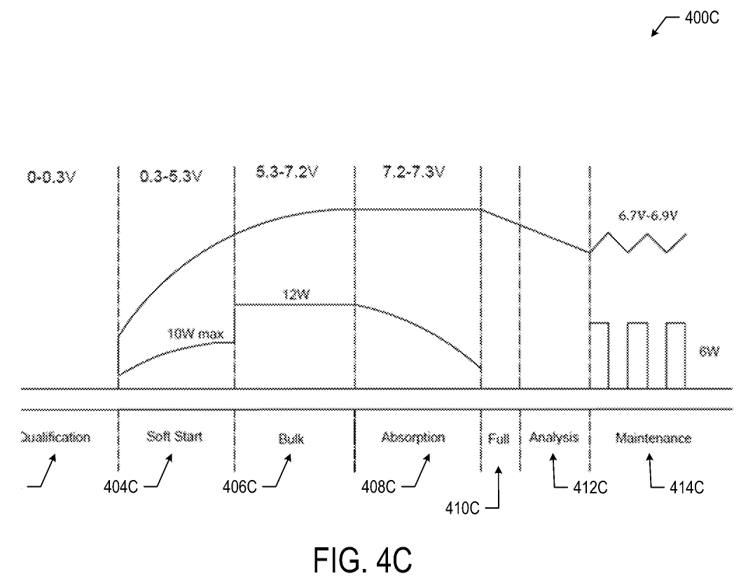

Turning to FIGS. 4A, 4B, and 4C, example charging profiles are shown. For example, a first charging profile (400A) for a 12V mode or a 12V AGM mode is shown in FIG. 4A. As shown, the first charging profile (400A) includes the qualification stage (402A), the soft start stage (404A), the bulk stage (406A), the absorption stage (408A), the full stage (410A), the analysis stage (412A), and the maintenance stage (414A).

Similarly, a second charging profile (400B) for a 12V LiFePO4 mode is shown in FIG. 4B, and includes the qualification stage (402B), the soft start stage (404B), the bulk stage (406B), the absorption stage (408B), the full stage (410B), and the recharging stage (416B). Lastly, a third charging profile (400C) for a 6V mode is shown in FIG. 4C and includes the qualification stage (402C), the soft start stage (404C), the bulk stage (406C), the absorption stage (408C), the full stage (410C), the analysis stage (412C), and the maintenance stage (414C).

It will be appreciated that the charging profiles (400A), (400B), (400C) are example charging profiles and the charging profiles can include any number of charging profiles. Further, the charging profiles can include any number of stages for any type of battery.

In another example, if the selected mode (310) is the repair mode, a repair protocol will be selected for repairing the battery (204). The repair mode can be applied to, for example, lead-acid batteries and provide a controlled recovery and/or conditioning cycle for lead-acid batteries. The repair protocol can include, for example, running a voltage check prior to activating the repair mode. If the battery voltage measurement is greater than a predetermined repair threshold, then the repair mode will not be activated. If the battery voltage measurement is less than the predetermined repair threshold and greater than a minimum battery voltage measurement, then the repair mode will activate and apply power to the battery no greater than a maximum repair power. The display (116) may display the repair mode icon (134) and the charging process indicator(s) (124) to indicate the repair progress. The repair mode may end automatically after a repair time (e.g., four hours) has elapsed.

In other embodiments, the selected mode (310) can also include a safety override or force start mode. Such force start mode may be used on, for example, LiFEPO4 batteries in which a hardware protection for over discharge is triggered and the force start mode can override the hardware protection. When the force start mode is activated, output to the battery will be forced on and the charger (100) will enter the soft start stage. The charger (100) will then monitor the output current and if the current is 0A for more than a force start time threshold (e.g., 30 seconds), the charger (100) will turn off the output and the display (116) will display, for example, the caution icon (146) together with the battery fault icon (148). Other example precautions include monitoring the output current and, if an over current or short circuit is detected, the charger (100) will turn off the output and the display (116) will display, for example, the caution icon (146) together with the battery fault icon (148).

The dataflow (300) also includes conducting one or more safety checks (314) using one or more safety check workflows. As previously described, the safety check workflows can include, for example, detecting for reverse polarity, checking for short circuit problems, detecting internal and external temperatures, protecting against over voltage, checking timing of charging.

If the safety check fails, the dataflow (300) proceeds to check if the charger (100) times out (316). The display (116) may also display an icon indicating that the safety check has failed. For example, the display (116) may display the caution icon (146), the first temperature icon (144)(1) to indicate that the charger (100) is exceeding a first temperature threshold, the second temperature icon (144)(2) to indicate that the charger (100) is below a second temperature threshold, the reverse connection indicator (142) when a reverse connection is detected, and a low temperature indicator (132) indicating that external temperatures are below, for example, freezing temperatures, or any combination of icons.

The charger (100) times out if the charger (100) receives no new inputs or changes, indicating that the charger (100) is no longer in use. If the charger (100) times out, then output from the charger (100) is disabled (324). If the charger (100) does not time out, the dataflow (300) returns to repeat the safety checks (314).

The dataflow (300) proceeds to activating an output power (318) when the safety checks (314) pass. Activating the output power (318) leads to initiating the charging process (320) and allowing the battery (204) to be charged. The dataflow (300) includes determining if the charging process has ended (322) after a time period. If the charging process has ended (322), then output from the charger (100) is disabled (324).

If the charging process has not ended (322), then the dataflow (300) includes checking if a safety event is triggered (326). The safety event can be the same as or similar to the safety checks and can include, for example, detecting for reverse polarity, checking for short circuit problems, etc. If the safety event is not triggered (326), then the dataflow returns to initiating the charging process (320).

If the safety event is triggered (326), then output from the charger (100) is disabled (324) and the display (116) may provide an indicator indicating why the output from the charger (100) is disabled (324). For example, the display (116) may display an icon indicating an issue with the internal component’s temperature being outside of the working temperature range or an issue with the battery.

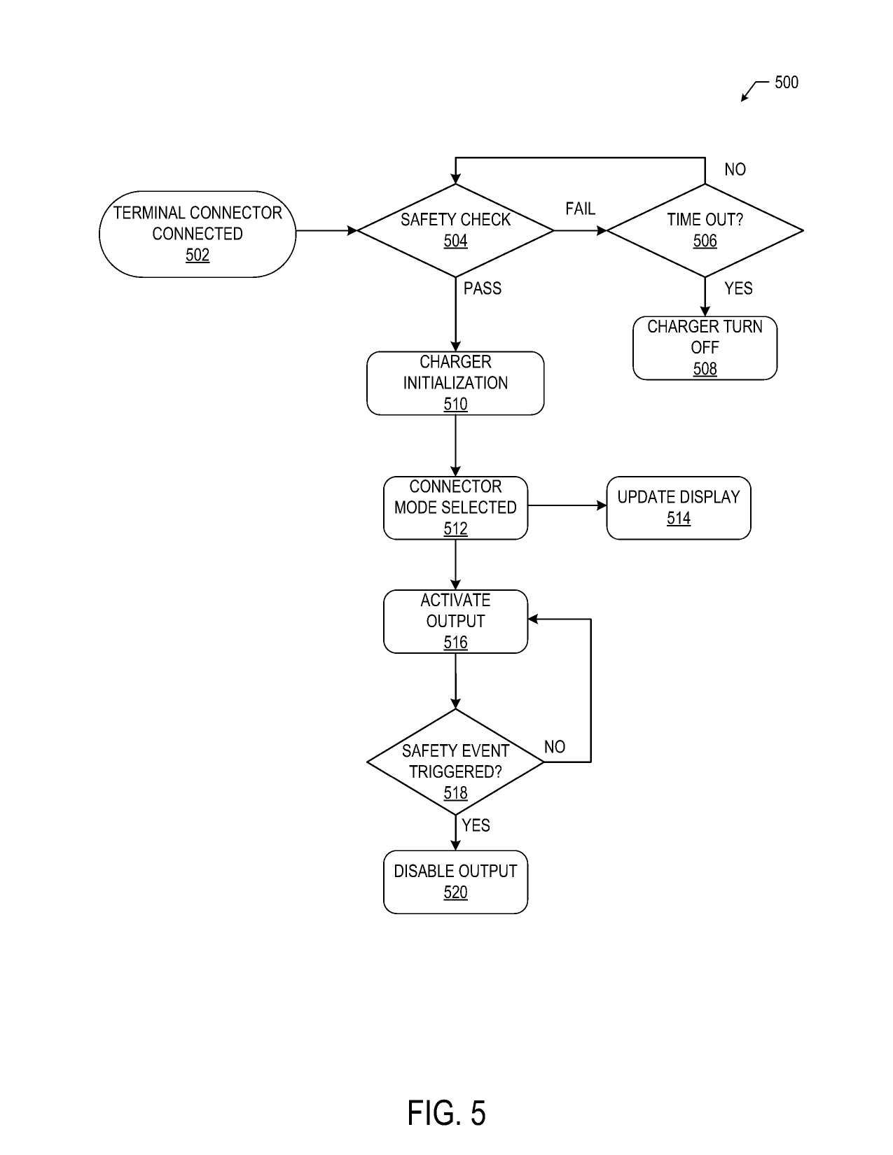

Turning to FIG. 5, a dataflow (500) illustrating a power flow from terminal connectors such as the terminal connectors (102) to a USB connector such as the USB connector (104) is shown. The dataflow (500) begins when the terminal connectors (102) and are connected (502) to, for example, a battery such as the battery (204). Connecting the terminal connectors (102) begins one or more safety checks (504), which may be the same as the one or more safety checks (314) of the dataflow (300).

If the safety check fails, the dataflow (500) proceeds to check if the charger (100) times out (506). The charger (100) times out if the charger (100) receives no new inputs or changes, indicating that the charger (100) is no longer in use. If the charger (100) times out, then the charger (100) is turned off (508). If the charger (100) does not time out, the dataflow (300) returns to repeat the safety checks (514).

If the safety checks (504) pass, then the charger is initialized (510) and a connector mode for charging an electronic device via the USB connector (104) or the output ports (120) is selected (512). The display (116) is then updated to display, for example, the active mode, and the output power is activated (516) to charge the electronic device. The output power is monitored to determine if a safety event is triggered (518) (which may be the same as the safety checks) and if the safety event is not triggered, the output power is allowed to continue being activated. If the safety even is triggered, then output from the charger (100) is disabled (520).

It will be appreciated that the dataflows (300) and (500) can include more or less steps or actions and that any step or combination of steps can be repeated.

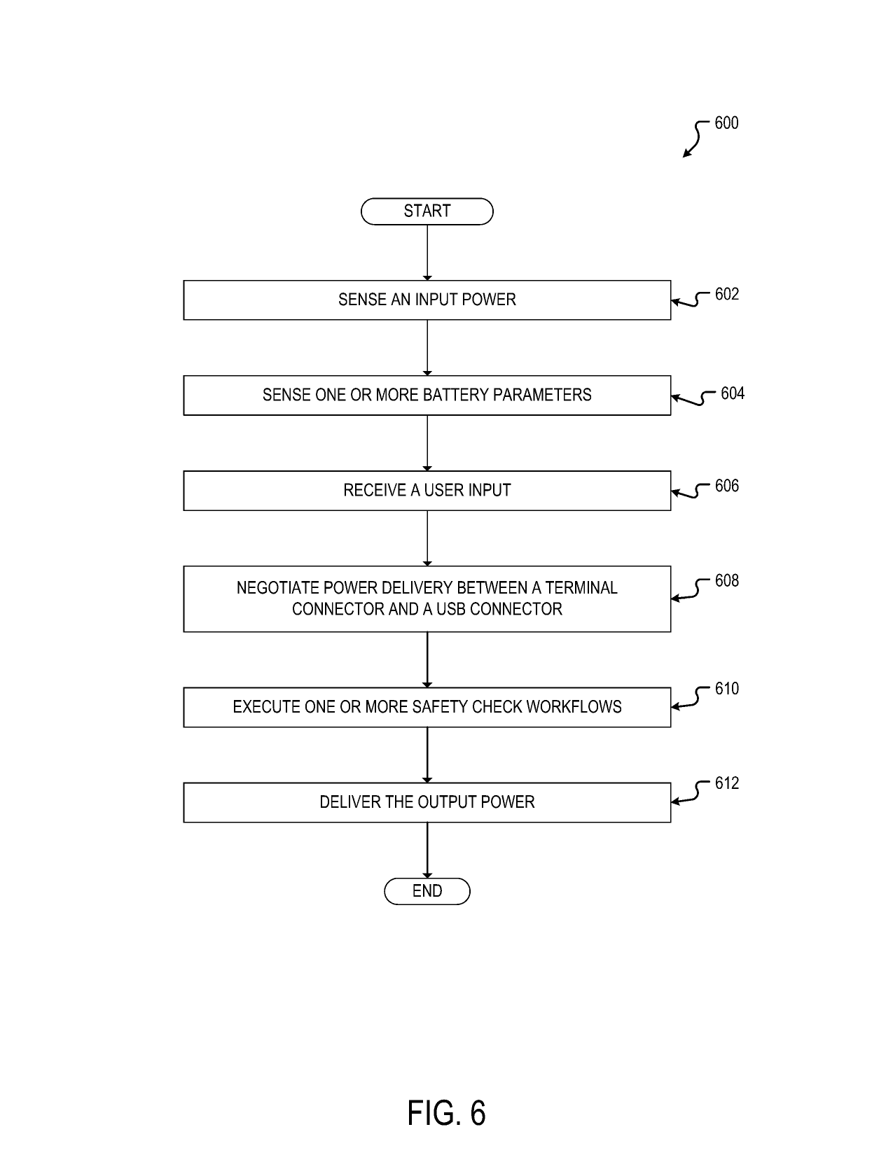

Turning to FIG. 6, a method (600) of using a charger such as the charger (100) is illustrated.

Step (602) of the method (600) includes sensing an input power. The input power can be sensed at a terminal connector such as the terminal connector (102) or a USB connector such as the USB connector (104). The input power can be supplied by a power source such as the power source (202) or a battery such as the battery (204). The input power can be sensed by a sensing circuit such as the sensing circuit (208) via a power control circuit such as the power control circuit (200) or a battery charging circuit such as the battery charging circuit (206).

Step (604) of the method (600) includes sensing one or more battery parameters. The one or more battery parameters can be sensed by the sensing circuit via the battery charging circuit. The one or more battery parameters can include, for example, a battery voltage, a battery current, a battery condition, a battery temperature, or the like.

Step (606) of the method (600) includes receiving a user input. The user input may be received via one or more user input devices such as the user input devices (118). The user input may include selection of a mode from multiple modes for charging the battery, repairing the battery, or charging an electronic device or output device such as the output device (202).

Step (608) of the method (600) includes negotiating power delivery between a terminal connector and a USB connector. The power delivery is negotiated by the power control circuit. Negotiating the power delivery can include one or more steps executed by the power control circuit such as, for example, receiving, from the USB connector, information about an input power source; receiving, from the terminal connectors, information about a requested power output; and approving the requested power output when the input power source is determined to be able to supply the requested power output.

Step (610) of the method (600) includes executing one or more safety check workflows. As previously described, the one or more safety check workflows can include detecting for reverse polarity, checking for short circuit problems, detecting internal and external temperatures, protecting against over voltage, and checking timing of charging. The safety check workflows can be executed by the battery charging circuit (206).

Step (612) of the method (600) includes delivering the output power. The output power is delivered by the terminal connector to the battery. Alternatively, the output power is delivered by the USB connector or the output ports to the output devices or electronic devices. In such embodiments, the battery charging circuit includes a DC-to-DC charging circuit (214) to enable DC-to-DC charging from the battery to the output devices.

The method (600) can include more or less steps and any step or combination of steps can be repeated.

The adaptive battery charger as described above provides many benefits and applications. For example, the adaptive battery charger can be integrated for off-grid use with solar power sources. Such integration enables the adaptive battery charger to directly interface with USB-C solar panels and bypass the need for external controllers typically used in conjunction with solar panels. Thus, the adaptive battery charger has easy compatibility with power banks or power stations that can act as an intermediary in low light conditions.

The adaptive battery charger can also be used remotely and is portable. The adaptive battery charger as described eliminates dependency on an AC wall outlet (e.g., mains) and facilitates charging when a mains power source is not readily available or accessible. The adaptive battery charger also facilitates charging batteries anywhere via USB-C power sources.

The adaptive battery charger also has versatility in that the adjustable output voltage replaces the need to have multiple chargers and access to lower voltage power sources still ensures charging. The adaptive battery charger is also easy to use as an OLED rotary dial with application presets with dynamic voltage control that facilitates the charging process for users who are not aware of battery sizing charge parameters and constraints.

The adaptive battery charger is also simple to use and bypasses the need for use of external charge controllers. The USB-C plug-in-play with power bank, power station, and/or solar panel also reduces reliance on grid power.

The adaptive battery charger also has a USB-C for battery charging and can use USB-C power input for universal compatibility with modern power sources (i.e., solar generators). The adaptive battery charger also includes application specific presets that are preprogrammed and are easy to navigate on a rotary dial presets based on application type. The application specific presets dynamically adjust voltages providing elevated ease of use. Further, extended application presets are automatically correlated to varying battery sizes.

The adaptive battery charger also advantageously includes an integration of a DC-to DC charger. In such integration, when the adaptive battery charger is in a USB-C power mode, the adaptive battery charger serves to extract power from, for example, the battery of a running vehicle to charge a power station or other electronic device.

The adaptive battery charger can be used for off-grid charging. For example, a user can charge and maintain a 12V lawn mower battery, stored in a remote shed (where no main power is available) using a USB-C solar panel and connected to a solar generator (power bank / power station) during the off-season.

In another example, the adaptive battery charger can also be used for emergency charging. For example, a driver can revive a dead battery for a vehicle in a remote parking lot by connecting a power station via the USB-C input of the battery charger. In another example, the adaptive battery charger can be also used for marine charging. For example, a boater can recover a bilge pump operation after a rainy, overnight fishing expedition by connecting the battery charger to a portable solar generator.

In still another example, the adaptive battery charger can also be used for USB-C output charging. For example, during a severe storm-induced power outage, a user can connect to a vehicle for a makeshift power source. The DC-to-DC function in the USB-C output mode allows the user to rapidly recharge a power station or use it in pass-through mode to keep essentials running until the grid power is restored.

Although exemplary embodiments of the invention have been described with reference to attached drawings, those skilled in the art nevertheless will apprehend variations in form or detail that are consistent with the scope of the invention as defined by the appended claims.

What is claimed is:

1. An adaptive battery charger comprising:
a terminal connector configured to at least one of deliver an output power or to receive an input power;
a USB connector configured to at least one of deliver the output power or to receive the input power;
a power control circuit configured to (i) receive the input power, (ii) and negotiate power delivery between the terminal connector and the USB connector;
a battery charging circuit configured to (i) receive the input power from the power control circuit and deliver the output power, and (ii) execute one or more safety check workflows prior to delivering the output power;
a sensing circuit configured to (i) sense the input power via the power control circuit and one or more battery parameters via the battery charging circuit, and (ii) output sensor data corresponding to the input power and the one or more battery parameters; and
a controller configured to (i) receive the sensor data, (ii) generate one or more commands based on the sensor data, and (iii) output the one or more commands to the power control circuit and the battery charging circuit to control delivery of the output power to charge an output device.

2. The adaptive battery charger of claim 1, wherein the controller is configured to output user readable data, and wherein the adaptive battery charger further comprises:
a display configured to (i) display the user readable data, and (ii) to receive user input.

3. The adaptive battery charger of claim 2, wherein the user readable data comprises at least one of voltage, current, charge levels, or a selected mode.

4. The adaptive battery charger of claim 2, wherein the controller is configured to receive the user input and to generate the one or more commands further based on the user input.

5. The adaptive battery charger of claim 3, wherein the user input comprises the selected mode of a plurality of modes, and wherein each mode corresponds to a preset battery configuration.

6. The adaptive battery charger of claim 1, wherein the input power is received at the USB connector, and the output power is delivered at the terminal connector.

7. The adaptive battery charger of claim 6, wherein the terminal connector is connected to a battery and the USB connector connected to a power delivery source.

8. The adaptive battery charger of claim 1, further comprising:
a terminal connector circuit configured to receive input power at the terminal connector, and wherein the input power is received at the terminal connector, and the output power is delivered at the USB connector.

9. The adaptive battery charger of claim 8, wherein the terminal connector is connected to a battery and the USB connector is connected to an output device receiving power from the adaptive battery charger.

10. The adaptive battery charger of claim 8, wherein the terminal connector circuit is configured to connect to a battery to detect real-time battery conditions and to at least one of allow a charge or a discharge from the battery.

11. The adaptive battery charger of claim 8, wherein the battery charging circuit includes a DC-to-DC circuit configured to receive DC input power and to deliver DC output power.

12. The adaptive battery charger of claim 1, wherein the input power comprises an input voltage and an input current and the output power comprises an output voltage and an output current.

13. The adaptive battery charger of claim 9, wherein the input voltage is different from the output voltage.

14. The adaptive battery charger of claim 9, wherein the input current is different from the output current.

15. The adaptive battery charger of claim 1, wherein the USB connector comprises USB-C.

16. The adaptive battery charger of claim 1, further comprising:
one or more output ports.

17. The adaptive battery charger of claim 1, wherein the power control circuit negotiates power delivery between the terminal connector and the USB connector by executing a plurality of operations comprising the steps of:
receiving, from the USB connector, information about an input power source;
receiving, from the terminal connector, information about a requested power output; and
approving the requested power output when the input power source is determined to be able to supply the requested power output.

18. An adaptive battery charger comprising:
a terminal connector configured to at least one of deliver an output power or to receive an input power;
a terminal connector circuit configured to receive the input power at the terminal connector;
a USB connector configured to at least one of deliver the output power or to receive the input power;
a power control circuit configured to (i) receive the input power, (ii) and negotiate power delivery between the terminal connector and the USB connector;
a battery charging circuit configured to (i) receive the input power from the power control circuit and deliver the output power, and (ii) execute one or more safety check workflows prior to delivering the output power, wherein the battery charging circuit includes a DC-to-DC circuit configured to receive DC input power and to deliver DC output power;
a sensing circuit configured to (i) sense the input power via the power control circuit and one or more battery parameters via the battery charging circuit, and (ii) output sensor data corresponding to the input power and the one or more battery parameters; and
a controller configured to (i) receive the sensor data, (ii) generate one or more commands based on the sensor data, and (iii) output the one or more commands to the power control circuit and the battery charging circuit to control delivery of the output power to charge an output device.

19. An adaptive battery charger comprising:
a terminal connector configured to at least one of deliver an output power or to receive an input power;
a terminal connector circuit configured to receive the input power at the terminal connector;
a USB connector configured to at least one of deliver the output power or to receive the input power;
a power control circuit configured to (i) receive the input power, (ii) and negotiate power delivery between the terminal connector and the USB connector;
a battery charging circuit configured to (i) receive the input power from the power control circuit and deliver the output power, and (ii) execute one or more safety check workflows prior to delivering the output power, wherein the battery charging circuit includes a DC-to-DC circuit configured to receive DC input power and to deliver DC output power;
a sensing circuit configured to (i) sense the input power via the power control circuit and one or more battery parameters via the battery charging circuit, and (ii) output sensor data corresponding to the input power and the one or more battery parameters; and
a controller configured to (i) receive the sensor data, (ii) generate one or more commands based on the sensor data, (iii) output the one or more commands to the power control circuit and the battery charging circuit to control delivery of the output power to charge an output device, and (iv) output one or more user-perceptible indicators correlating to one or more charging speed tiers based on the negotiated power delivery.

20. The adaptive battery charge of claim 19, wherein the one or more charging speed indicators comprise at least three charging indicators comprising a first charging indicator corresponding to the negotiating power delivery being equal to or less than a first power threshold, a second charging indicator corresponding to the negotiating power delivery being equal to or less than a second power threshold, and a third charging indicator corresponding to the negotiating power delivery being equal to or less than a third power threshold, and wherein the third power threshold is greater than the second power threshold and the second power threshold is greater than the first power threshold.
